(19) United States
(12) Patent Application Publication
(10) Pub. No.: US 2016/0104083 A1
(43) Pub. Date: Apr. 14, 2016

(54) METHOD OF ACHIEVING HEALTH AGENCY AIMS THROUGH A PERFORMANCE MANAGEMENT DASHBOARD

(71) Applicant: California State University Fresno, Fresno, CA (US)

(72) Inventors: Donna DeRoo, Clovis, CA (US); Allison Hensleit, San Leandro, CA (US); Ashley Hart, Sanger, CA (US)

(73) Assignee: California State University, Fresno

(21) Appl. No.: 14/512,276

(22) Filed: Oct. 10, 2014

(51) Int. Cl. G06Q 10/06

(52) U.S. Cl. CPC G06Q 10/0637

(57) ABSTRACT

The present invention is directed to a management method to achieve organizational aims, comprising listing organizational aims, determining one or more goals to meet in order to reach the organizational aims, defining one or more performance measures each having numeric year to date measure data to measure attainment of each of the goals in a twelve month period, describing why each of the performance measures was chosen, naming person or personnel position responsible for ensuring entry of the year to date measure data, specifying frequency of entry of the year to date measure data within a twelve month period, labeling the year to date measure data with an appropriate unit of measure, stating a source from which the year to date measure data is to be collected, demarcating an annual target and a red line target for each of the year to date measure data, entering the year to date measure data to create entered year to date measure data, updating the year to date measure to create updated year to date measure data, calculating a progression of each of the entered year to date measure data and/or each of the updated year to date measure data in relation to the annual target and the red line target, and displaying the progression of the entered year to date measure data and/or the updated year to date measure data over the twelve month period.

### BACKGROUND

A. Field of the Invention

The present invention relates to a method of setting aims, defining goals and tracking performance measures through use of a management dashboard.

B. Description of the Prior Art

“Pay-for-performance” is an umbrella term for initiatives aimed at improving the quality, efficiency, and overall value of health care. These arrangements provide financial incentives to hospitals, physicians, and other health care providers to carry out such improvements and achieve optimal outcomes for patients. The Patient Protection and Affordable Care Act (hereinafter “Affordable Care Act”) expands the use of pay-for-performance approaches in Medicare in particular and encourages experimentation to identify designs and programs that are most effective.

A provision of the (Affordable Care Act) requires health plans to submit reports each year demonstrating how they reward health care quality through market-based incentives in benefit design and provider reimbursement structures. The U.S. Secretary of Health and Human Services (HHS) will develop requirements for health plans to report on their efforts to: improve health outcomes, prevent hospital readmissions, ensure patient safety and reduce medical errors, and implement wellness and health promotion activities. Both employer group health plans, including self-insured plans, individual market plans, and qualified health plans sold through the insurance exchanges are required to submit such reports.

Health plan performance is measured through an array of standardized performance measures assessing preventive care, clinical processes, and intermediate outcomes (e.g., blood pressure or cholesterol levels) as well as care experiences and outcomes (e.g., functional status).

1. Public Health Department Accreditation

Under the Affordable Care Act, federal regulation will require accreditation of all public health departments through the public health accreditation board in the near future. Part of the public health department accreditation—covered by Domain 9, Standard 9.1 (Performance Management System)—requires monitoring achievement of organizational objectives. Domain 9, Standard 9.2 requires development and implementation of quality improvement processes integrated into organizational practice, processes and interventions.

“Accreditation” is a comprehensive evaluation process in which a health care organization's systems, processes and performance are examined by an impartial external organization (“accrediting body”) to ensure that it is conducting business in a manner that meets predetermined criteria and is consistent with national standards. States currently use accreditation of a variety of health care organizations as part of their overall strategy to evaluate and improve the quality and cost-effectiveness of care and to promote compliance with state and federal laws.

The Affordable Care Act requires that, beginning in 2014, all health plans offered through state insurance exchanges “ . . . must be accredited with respect to local performance on clinical quality measures such as the Healthcare Effectiveness Data and Information Set (HEDIS), patient experience ratings on a standardized Consumer Assessment of Healthcare Providers and Systems (CAHPS) survey, as well as consumer access, utilization management, quality assurance, provider credentialing, complaints and appeals, network adequacy and access, and patient information programs by any entity recognized by the Secretary for the accreditation of health insurance issuers or plans (so long as any such entity has transparent and rigorous methodological and scoring criteria).”

Currently, most county public health agencies around the nation do not have performance management systems implemented to track public health agency performance measures or to identify strategic aims and goals.

2. Performance Management Plans and Dashboards

Performance management plans ensure that aims are clearly defined, and goals are consistently being met in an effective and efficient manner. Performance management can focus on the performance of an organization, a department, employee, or even the processes to build a product of service, as well as many other areas. Performance management is also known as a process by which organizations align their resources, systems and employees to strategic objectives and priorities.

In management information systems, a dashboard is an easy to read, real-time user interface, showing a graphical presentation of the current status (snapshot) and historical trends of an organization's key performance indicators to enable instantaneous and informed decisions to be made at a glance. In real-world terms, a “dashboard” is another name for “progress report” or “report.” Often, the “dashboard” is linked to a database which allows the report to be constantly updated. Digital dashboards allow managers to monitor the contribution of the various departments in their organization. To gauge exactly how well an organization is performing overall, digital dashboards capture and report specific data points from each department within the organization, thus providing a snapshot of performance.

The prior art includes many performance management plans and dashboards, but none that appropriately track the performance measurements necessary for public health agency accreditation under the Affordable Care Act.

U.S. Pat. No. 8,195,503 describes achieving an objective by collecting data related to the objective and determining a set of drivers related to the objective. The method includes calculating a gap for each driver between a baseline and a goal for the objective. The method does not allow the user to program how often the drivers are collected, explain why the drivers were chosen, nor who is responsible for collecting the set of drivers. The method does not have a color-coded alert system to track how close an objective is to being met.

U.S. Pat. No. 8,275,651 describes a behavior improvement system by allowing the user to set a goal and to set an action plan to realize the goal, and to carry out evaluations to determine whether the goals are met. The system does not allow customization of different types of data to determine when the goals are met apart from evaluations. Also, the system does not allow customization of different people to track various aspects of the action plan. The system does not have a color-coded alert system to track how close a goal is to being met.

U.S. Pat. Pub. No. US 2012/0072252 A1 describes a dashboard to assess the ability of workers in an organization to accomplish one or more organizational goals. The dashboard permits the user to define competencies the employees are expected to have, to define a skill set to carry out each competency, and to track the acquisition of the skill set. The dashboard does not describe tracking organizational goals in any way apart from employee competencies. Also, the dashboard does not allow customizing different people responsible for analyzing when each skill set is acquired. There is no color-coded alert system to track how close each competency is to being reached.

### SUMMARY OF THE INVENTION

The present invention is directed to a management method to achieve organizational aims, comprising listing organizational aims, determining one or more goals to meet in order to reach the organizational aims, defining one or more performance measures each having numeric year to date measure data to measure attainment of each of the goals in a twelve month period, describing why each of the performance measures was chosen, naming person or personnel position responsible for ensuring entry of the year to date measure data, specifying frequency of entry of the year to date measure data within a twelve month period, labeling the year to date measure data with an appropriate unit of measure, stating a source from which the year to date measure data is to be collected, demarcating an annual target and a red line target for each of the year to date measure data, entering the year to date measure data to create entered year to date measure data, updating the year to date measure to create updated year to date measure data, calculating a progression of each of the entered year to date measure data and/or each of the updated year to date measure data in relation to the annual target and the red line target, and displaying the progression of the entered year to date measure data and/or the updated year to date measure data over the twelve month period.

In one aspect of the invention, the listing step comprises identifying priorities and ensuring the organizational aims achieve each of the priorities. In a second aspect of the invention, the specifying step comprises of stating that the year to date measure data are entered monthly, quarterly, biannually, or annually. In another aspect of the invention, the displaying step further comprises showing a color-coded alert corresponding to the progression. In yet another aspect of the invention, the color-coded alert may show red when the year to date measure data has not surpassed the red line target. Alternatively, the color-coded alert may show yellow when the year to date measure data has surpassed the red line target and has not yet met the annual target. The color-coded alert may show green when the year to date measure data has met or surpassed the annual target.

The management method of the present invention may have the displaying step comprising showing a bar chart showing a development of the year to date measure data over the twelve month period. In one aspect of the invention, the labeling step comprises choosing a unit of measure from the following: number, percentage, and dollar amount. In another aspect of the invention, the claimed method further comprises documenting protocols for collecting the year to date measure data from the source. In yet another aspect of the invention, the claimed management method is carried out by Microsoft Excel. In the invention, the displaying step may utilize a dashboard.

In the present invention, the listing step may comprise of listing organizational aims for each of a plurality of programs. In one aspect of the invention, the claimed method may further comprise summarizing in a cumulative display the progression of each of the performance measures by the year to date measure data in relation to the annual target and the red line target for each of the programs, and presenting the cumulative display in a central dashboard. In yet another aspect of the invention, the claimed method may further comprise recording a year end measure data for each of the performance measures for each of several consecutive twelve month periods, and evaluating a development of each of the year end measure data against the annual target and the red line target over the several consecutive twelve month periods.

### BRIEF DESCRIPTION OF THE DRAWINGS

FIG. 1 is a flowchart showing an overview of the claimed method.

FIG. 2 is a flowchart showing how organizational aims are listed, how goals are determined, and how performance measures are defined.

FIG. 3A is a depiction of how one aim can be associated with an infinite number of goals, and how each goal can be associated with an infinite number of performance measures.

FIG. 3B is a depiction of how any aim can be associated with an infinite number of goals, and how each goal can be associated with an infinite number of performance measures.

FIG. 4 shows how the claimed method requires, for each performance measure, describing step, naming step, specifying step, labeling step, stating step, and on some occasions the documenting step.

FIG. 5 shows how the performance measure progression is calculated and displayed in a color-coded alert system.

FIG. 6 shows a blank Microsoft Excel worksheet that can be formatted and used to carry out the claimed method.

FIG. 7 shows an embodiment of a Measure Definitions worksheet.

FIG. 8 shows one embodiment of a Data Entry worksheet, in non-expanded form.

FIG. 9 shows an embodiment of a Data Entry worksheet in an expanded form, with monthly measure data entries.

FIG. 10 shows an embodiment of a Data Entry worksheet in an expanded form, with quarterly measure data entries.

FIG. 11A shows an embodiment for a Dashboard worksheet for one performance measure.

FIG. 11B shows an embodiment for a Dashboard worksheet for six different performance measures.

FIG. 12 shows an embodiment of a Graphical Summary worksheet.

FIG. 13 shows an embodiment of a Department dashboard displaying cumulative information for performance measures for each of the Department's programs.

### DETAILED DESCRIPTION OF THE PREFERRED EMBODIMENTS

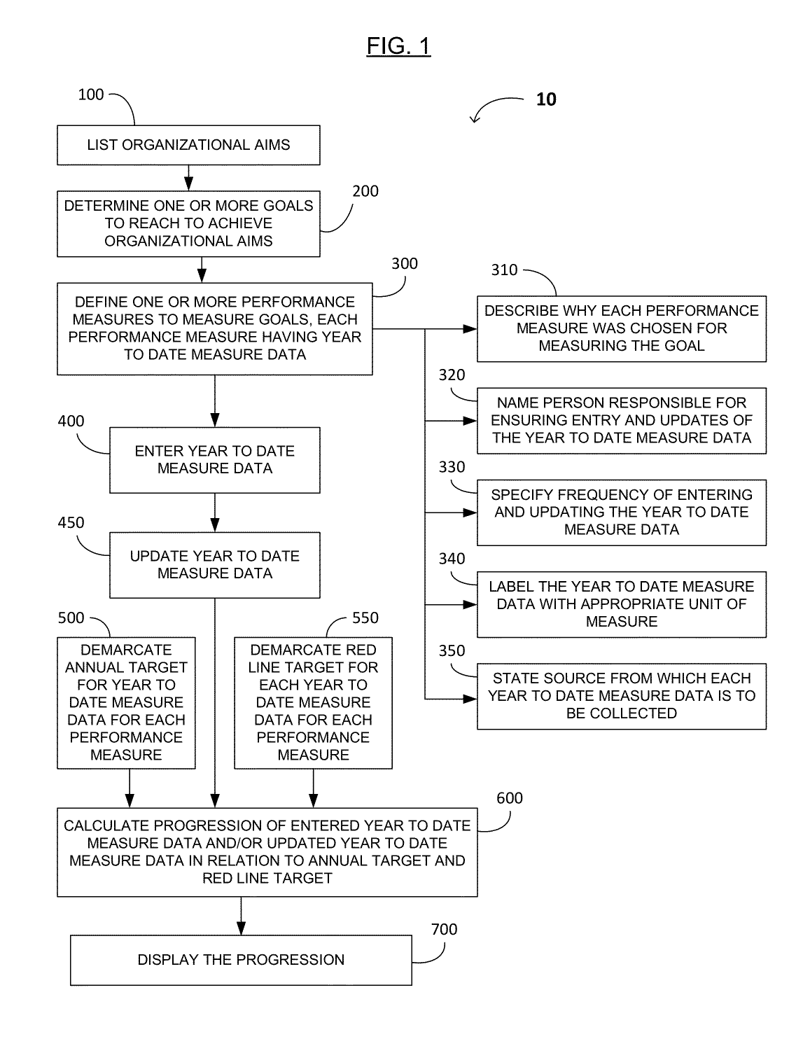

With reference to FIGS. 1-13, the preferred embodiments of the present invention are set forth. The present invention relates to a management method of achieving organizational aims by allowing the user to customize aims, set goals to achieve those aims, define performance measures to ensure goals are met, and to calculate the progression of those performance measures as shown by progression of measure data associated with the performance measures. The claimed method may include presenting information in a dashboard to show the progression of measure data to achieve customized goals and aims. The claimed method will help a public health agency meet the Public Health Accreditation Board Requirements in support of the Affordable Care Act.

The claimed method may be practiced by setting up a Microsoft Excel program, formatting the Microsoft Excel worksheets, installing the Microsoft Excel worksheets on one or more computers, and running the Microsoft Excel worksheets.

### A. DEFINITIONS

The terms “aim,” “organizational aim,” and “aim statement,” are used interchangeably and refer to the same concept.

The terms “goal,” “organizational goal,” and “goal statement,” are used interchangeably and refer to the same concept.

The terms “bar chart” and “bar graph” are used interchangeably and refer to the same concept.

### B. OVERVIEW OF THE MANAGEMENT METHOD TO ACHIEVE ORGANIZATIONAL AIMS

The claimed method allows a user to customize organizational aims and to measure and track performance measures to ensure those aims are met in a timely manner. FIG. 1 shows a flow chart representing a high level overview of the claimed method including: listing organizational aims, determining goals to ensure achievement of the organization aims, defining one or more performance measures to measure each of the goals, entering the performance measures, demarcating annual target and red line target for each performance goal, and calculating and displaying the progression of the performance measures relative to the annual target and the red line target.

As shown in FIG. 1, the first step of claimed method 10 is listing step 100, for a user to list the organizational aims of the organization. After step 100 is completed, the user then progresses to determining step 200, to determine one or more goals to reach in order to achieve the organizational aims. Then, the user progresses to defining step 300, to define one or more performance measures to measure the determined goals. The performance measures of defining step 300 each have numeric year to date measure data, measuring how the performance measure is progressing through a twelve month time period. The year to date measure data defines the most current measure data available.

As shown in FIG. 1, to enable tracking the accurate and timely entry of the year to date measure data defined in defining step 300, claimed method 10 also includes at least five distinct steps: describing step 310, naming step 320, specifying step 330, labeling step 340, and stating step 350. In describing step 310, the user describes in narrative fashion why each performance measure was chosen for measuring the goal. In naming step 320, the user names the person responsible for entering the year to date measure data and updating the year to date measure data. In specifying step 330, the user specifies the frequency of entering and updating the year to date measure data. In labeling step 340, the user labels each year to date measure data with the appropriate unit of measure. In stating step 350, the user states the source from which the year to date measure data is to be collected, at the appropriate time.

After the user has defined the performance measures, described each one, named the person responsible for entering and updating the year to date measure data associated with each performance measure, specified the frequency of entry and update of each year to date measure data, labeled each year to date measure data with the appropriate unit of measure, and stated the source from which each year to date measure data is to be collected, then the year to date measure data are entered into a system carrying out claimed method 10.

In entering step 400, a user enters measure data into the Microsoft Excel worksheet or other computer program carrying out claimed method 10. In updating step 450, the user updates the year to date measure data by entering the most recently updated year to date measure data into a system carrying out claimed method 10, such as a Microsoft Excel program. The user can carry out updating step 450 one or more times during a twelve month period. In any twelve month period, entering step 400 is carried out once, and updating step 450 may be carried out one or multiple times.

Next, claimed method 10 requires demarcating annual target step 500 and demarcating red line step 550. Demarcating annual target step 500 requires the user to demarcate the annual target—the desired target—for the year to date measure data for the performance measure. Demarcating red line step 550 requires the user to demarcate the red line target—the minimally acceptable target—for the year to date measure data for the performance measure.

Next, claimed method 10 will take the numbers entered in step 500 and step 550 and carry out calculating step 600, in which the claimed method 10 will calculate the progression of entered year to date measure data and the updated year to date measure data in relation to the demarcated annual target and the demarcated red line target. Claimed method 10 also will carry out displaying step 700, which will visually display the progression of performance measures of each goal and how it relates to the annual target and the red line target.

### C. LISTING ORGANIZATIONAL AIMS, DETERMINING GOALS, DEFINING PERFORMANCE MEASURES

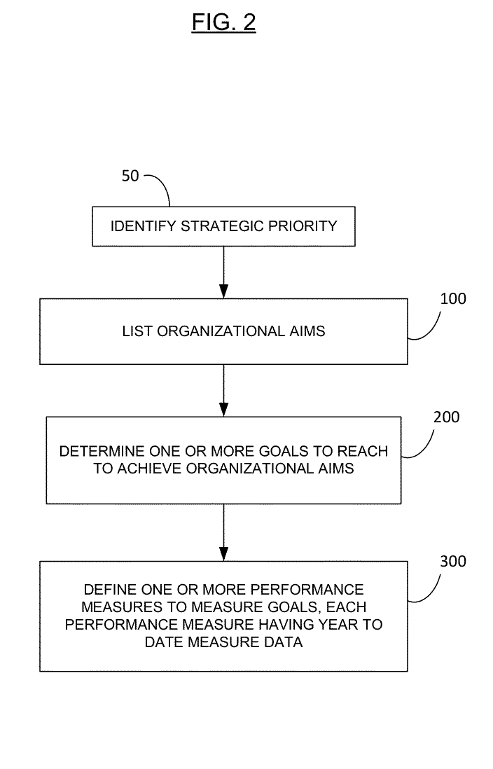

As shown in FIG. 2, an organizational aim, listed in listing step 200, should be something that advances the achievement of a public health department strategic priority. First, an organization should identify one or more strategic priorities that it is trying to achieve in identifying step 50. After identifying the priority or priorities, the user of the claimed method can progress to listing step 100 to list organizational aims related to achieving the strategic priority or priorities. The aim will be stated narratively as an aim statement. The user can customize and enter any aim statement he or she wishes. Aim statements answer the question: “How can we achieve the strategic priority?”

One example of a strategic priority facing some health agencies may be: reducing health disparities among women. An aim statement to achieve this strategic priority may be: reducing health disparities among women of childbearing age. Another aim statement to achieve this strategic priority may be: reducing health disparities among African American women.

As shown in FIG. 2, after listing the organizational aims, the user can proceed to determining step 200, to determine one or more goals for each aim to serve as guidelines for achievement of the aim. The goals are used to assess an organization's performance toward achieving the aim. The goal will be stated narratively as a goal statement. The user can customize and enter any goal statement he or she wishes. Goal statements answer the question: “What approach are we taking to achieve our aim statement?” For an aim such as “reducing health disparities for women of childbearing age,” the goals to ensure achievement of the aim could be: (1) increase awareness of health disparities of women of childbearing age through community education; and (2) provide group interventions and case management services to women of childbearing age.

In the claimed method 10, goals in determining step 200 are measured by performance measures having quantitative measure data to measure capacities, processes and/or outcomes relevant to meeting each goal. Defining step 300 allows the user to customize the appropriate performance measures for each goal. Measure data associated with the performance measure are the quantitative data that allow you to answer the question: “What data do we have available to assess our progress against our goals?” For a goal like “increase awareness of health disparities of women of childbearing age through community education,” performance measures may be: (1) percentage of providers who refer African American women to Maternal Health programs; (2) number of presentations to unique community organizations; and (3) number of African American women who are referred to Maternal Health programs. The measure data for performance measure (1), described above, would be the actual number corresponding to the percentage of providers who refer African American women to Maternal Health programs. The measure data for performance measure (2), described above, would be the actual number corresponding to the number of presentations to unique community organizations.

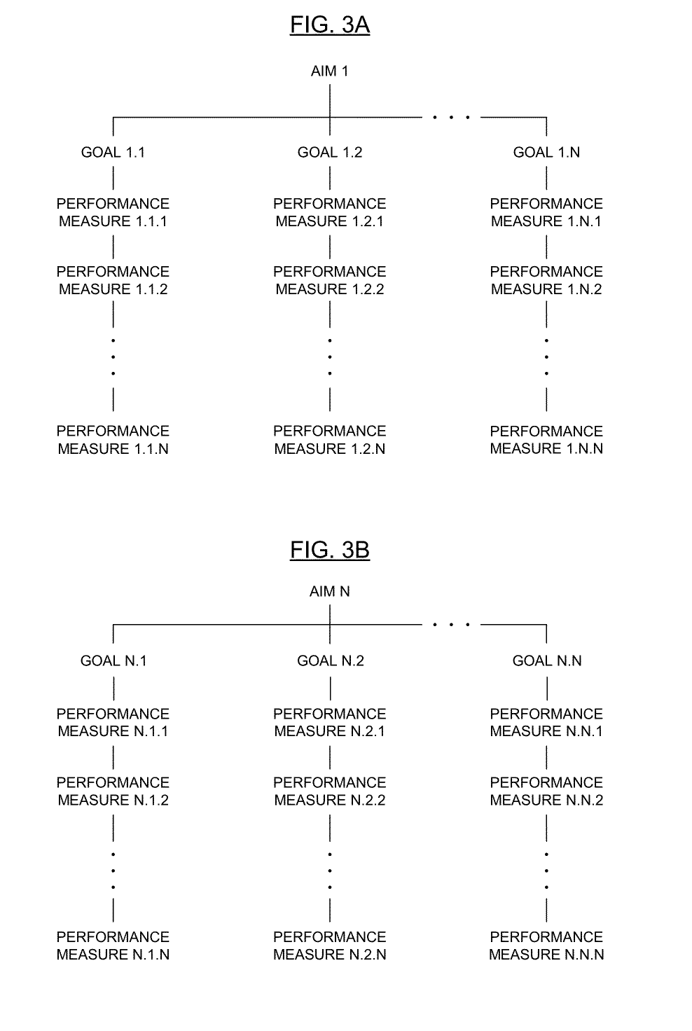

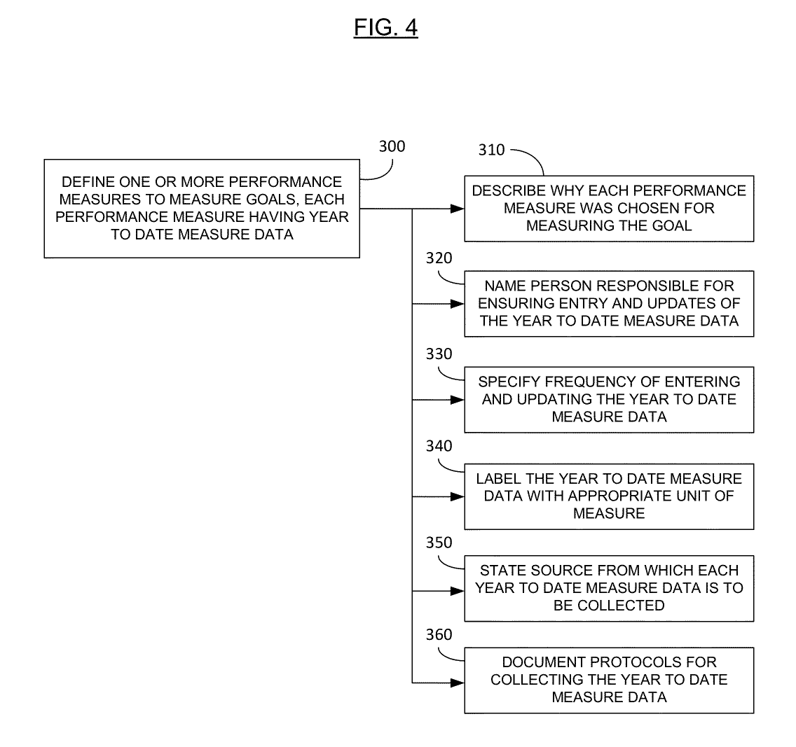

As shown in FIGS. 3A and 3B, the claimed method can have an infinite number of aims, an infinite number of associated goals, and an infinite number of associated performance measures. Each aim can have an infinite number of associated goals. Each goal can have an infinite number of associated performance measures. The association of the aims with its goals with its performance measures will be accomplished through a numbering convention that follows a logical format that is infinitely expandable.

The claimed method may accommodate any number of aims, goals, and performance measures. The claimed method is infinitely customizable and expandable. FIG. 3A shows one embodiment of a logical numbering convention for the claimed method that is infinitely expandable. As shown in FIG. 3A, for the first aim, numbered “AIM 1”, there can be associated multiple goals. The first goal may be numbered Goal 1.1, the second goal may be numbered Goal 1.2, and so on through the nth goal that will be numbered Goal 1.N.

As shown in FIG. 3A, for Goal 1.1., there can be associated performance measures that will follow a logical format that is infinitely expandable. The first performance measure may be numbered Performance Measure 1.1.1, the second performance measure may be numbered Performance Measure 1.1.2 through Performance Measure 1.1.N. For Goal 1.2., there can be associated Performance Measure 1.2.1, Performance Measure 1.2.2 through Performance Measure 1.2.N. For Goal 1.N., there can be associated Performance Measure 1.N.1, Performance Measure 1.N.2 through Performance Measure 1.N.N.

FIG. 3B shows one embodiment of a logical numbering system that is infinitely expandable. As shown in FIG. 3B, for any aim, termed “AIM N,” there can be associated an infinite number of goals, and such goals can have an infinite number of performance measures. For example, as shown in FIG. 3B, for any aim, labeled “AIM N”, there can be associated multiple goals, labeled Goal N.1, Goal N.2, and so on through Goal N.N.

For Goal N.1., there can be associated Performance Measure N.1.1, Performance Measure N.1.2, Performance Measure N.1.3, etc. through Performance Measure N.1.N. For Goal N.2., there can be associated Performance Measure N.2.1, Performance Measure N.2.2, Performance Measure N.2.3, etc. through Performance Measure N.2.N. For Goal N.N., there can be associated Performance Measure N.N.1, Performance Measure N.N.2, Performance Measure N.N.3, etc. through Performance Measure N.N.N.

### D. DEFINING, DESCRIBING, SPECIFYING, AND LABELING PERFORMANCE MEASURES

FIG. 4 shows a flow chart describing defining step 300 in relation to steps 310, 320, 330, 340, 350, and 360 of the claimed method 10 to define one or more performance measures, describe why each performance measure was chosen, name the person responsible for analyzing each performance measure, specify the frequency of analyzing the performance measure, label each performance measure, state the collection source for each performance measure, and document any special protocols for collecting certain performance measures.

As shown in FIG. 4, many data and information points will describe, define, specify, and guide the collection and entry of data corresponding to each performance measure. In defining step 300, the performance measure is defined in a short statement, such as: number of unique visitors to X website, number of clinics opened in rural Kern county, etc., or percentage of Hispanic women in Tulare county who seek prenatal screening. In describing step 310, a user will enter a narrative description. The user can customize and enter any performance measure description that he or she wishes. The performance measure description will answer the question: “why have we chosen this performance measure?” The performance measure description should be a short and concise statement. An example of a performance measure description is: “measures the effectiveness of health disparity communication and outreach.”

Also, as shown in FIG. 4, in naming step 320, each performance measure must be associated with the name or position title of the person responsible for entering and updating the year to date measure data for the performance measure. The naming step 320 must indicate the individual or personnel position or title responsible for entering the year to date measure data into a system carrying out claimed method 10. For the naming step 320, the user can customize and name any person or position he/she wishes. The named person or position may or may not be the individual who actually manually enters the performance measures into the system running the claimed method. However, the named person or position is responsible for making sure that the performance measure is ultimately entered, and updated as necessary.

As shown in FIG. 4, in specifying step 330, each performance measure must be associated with a specified timing or frequency of entry and update of year to date measure data. For each performance measure, there is a specific timeframe for which the year to date measure data must be entered into the system carrying out claimed method 10. The user can customize when each performance measure must be entered and/or updated. Some common entries for specifying the timing of entry and update of year to date measure data would be: monthly, quarterly, biannually, or annually.

If specifying step 330 specifies that year to date measure data for a performance measure should entered annually, then entering step 400 will be carried out once in a twelve month period and updating step 450 will not be carried out during that twelve month period. If specifying step 330 specifies that year to date measure data for a performance measure should entered quarterly, then entering step 400 will be carried out once in a twelve month period, after the third month. Then updating step 450 will be carried out three times during the twelve month period, after the sixth month, after the ninth month, and after the twelfth month.

As shown in FIG. 4, in labeling step 340, each year to date measure data must be labeled with the correct unit of measure. Each year to date measure data will be entered in numeric form. The year to date measure data must be labeled so that the user can make sense of the numeric entry. The user can customize and enter whatever unit of measure appropriate to describe the numeric year to date measure data data. Some common units of measure to be entered may be: percentage, number, and dollar amount.

Also as shown in FIG. 4, in stating step 350, each performance measure must be associated with a stated source from which the year to date measure data can collected or obtained. The stated source must be specific enough so that a person familiar with public health agencies will know what source is referenced. Some examples of performance measure sources include: (1) Automated Vital Statistics System; and (2) Black Infant Health Program Data.

For year to date measure data that are sourced from survey results and experiment results, the performance measure may be associated with a documented protocol so the identical survey or experiment may be carried out each time the year to date measure data is collected or obtained. If this is the case, then as shown in FIG. 4, documenting step 360 must be included as part of claimed method 10. In documenting step 360, the user can customize and enter any formula or protocol he or she wishes to document how a certain year to date measure data is obtained to measure a performance measure.

### E. DEMARCATING ANNUAL TARGET AND RED LINE TARGET FOR EACH PERFORMANCE MEASURE

As shown in FIG. 1, the claimed method 10 also requires demarcating a quantitative annual target and a quantitative red line target for each performance measure. The user can use the claimed method to demarcate any annual target and any red line target he/she wishes. To carry out demarcating annual target step 400, the entered annual target must be a measurable value that the year to date measure data ideally should meet and/or surpass within a twelve month period. To carry out demarcating red line target step 450, the entered red line target must be a measurable value that the year to date measure data must surpass within 12 months. The user sets a red line target such that any year to date measure data under the red line target would be deemed unacceptable.

For a performance measure such as “percentage of providers who refer African American women to Maternal Health programs,” a reasonable annual target may be 30%, and a reasonable red line target may be 10%. It is desirable that at least 30% of providers refer African American women to Maternal Health programs each year. It is unacceptable that 10% or less than 10% of providers refer African American women to Maternal Health programs each year.

As shown in FIG. 1, to carry out step 400, the user demarcates the annual target by entering a number in a system carrying out claimed method 10 for the annual target. The entered annual target number can be changed at any time. To carry out step 450, the user demarcates the red line target by entering a number in a system carrying out claimed method 10 for the red line target. The entered red line number can be changed at any time.

### F. ENTERING YEAR TO DATE MEASURE DATA

As shown in FIG. 1, after listing step 100, determining step, 200, and defining step 300, the user then uses the information described, named, specified, labeled, stated and documented in steps 310, 320, 330, 340, 350, and if needed, 360, to collect, enter, and update performance measures into a system carrying out claimed method 10. Entering step 400 comprises entering the collected year to date measure data to be linked to the correct performance measure, goal and aim. Updating step 450 comprises erasing the previously entered year to date measure data linked to a performance measure, goal, and aim, and entering a newly collected and calculated year to date measure data in the correct place within a system carrying out claimed method 10.

Entering step 400 takes place by a user entering year to date measure data into a spreadsheet, such as an Excel spreadsheet, carrying out the claimed method 10. The year to date measure data is collected from the source specified in stating step 350. The year to date measure data is entered according to the frequency in specifying step 330. The person or position named in naming step 320 is responsible for ensuring entering step 400 occurs in the timeframe of specifying step.

Updating step 450 may occur during a twelve month period if the specifying step specifies a frequency of monthly, bimonthly, quarterly, or biannually. Updating step 450 takes place by a user erasing the previously entered year to date measure data in a spreadsheet, such as an Excel spreadsheet, carrying out the claimed method 10, and entering in the most recent year to date measure data into the same place in the spreadsheet as the previously entered year to date measure data. The most recent year to date measure data is collected from the source specified in stating step 350. The year to date measure data is entered according to the frequency in specifying step 330. The most recent year to date measure data is updated by the person or position named in naming step 320 in the timeframe of specifying step.

### G. CALCULATING AND DISPLAYING THE MEASURE DATA PROGRESSION

After entering step 400, the claimed method 10 may calculate and display the progression of the year to date measure data toward the red line target and the annual target. By monitoring the displayed progression of year to date measure data associated with each of the performance measures, the user can quickly and easily analyze whether the goals, and aims will be met in a timely manner.

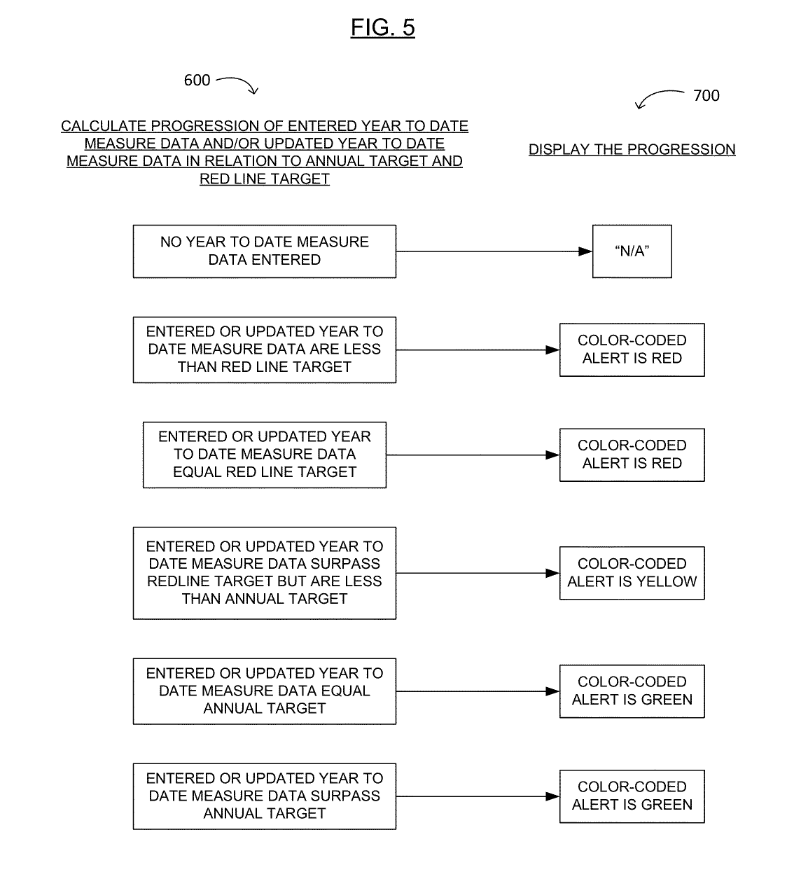

In FIG. 5, one embodiment of calculating step 600 and displaying step 700 are shown. When for any performance measure, no year to date measure data is entered in entering step 400, then there is no year to date measure data to calculate and the displaying step will display “NA” for “not available.” When for any performance measure, the entered or updated year to date measure data from entering step 400 is less than the demarcated red line target, then calculating step 600 will cause displaying step 700 to display an alert that is red in color. When for any performance measure, the entered or updated year to date measure data from entering step 400 equals the demarcated red line target, then calculating step 600 will cause displaying step 700 to display an alert that is red in color.

As shown in FIG. 5, When for any performance measure, the entered or updated year to date measure data from entering step 400 surpasses the demarcated red line target, but is less than the demarcated annual target, then calculating step 600 will cause displaying step 700 to display an alert that is yellow in color. When for any performance measure, the entered or updated year to date measure data from entering step 400 equals the demarcated annual target, then calculating step 600 will cause displaying step 700 to display an alert that is green in color. When for any performance measure, the entered or updated year to date measure data from entering step 400 surpasses the demarcated annual target, then calculating step 600 will cause displaying step 700 to display an alert that is green in color.

### H. CHRONICLING PROGRESSION OF MEASURE DATA

The performance measure progression, shown by year to date measure data, can be shown in color-coded alert systems within a twelve month period. Alternatively, the measure data progression can be chronicled graphically, such as in bar graphs. Within a twelve month period, the entered measure data can be chronicled in a bar graph, with each bar corresponding to the measure data entered according to the frequency specified in specifying step 330. For example, if a performance measure was specified in specifying step 330 to be entered quarterly, then a bar graph in the eleventh month of the first year would display three bars, the first bar corresponding to the year to date data after the third month, the second bar corresponding to the year to date data after the sixth month, and the third bar corresponding to the year to date data after the ninth month.

Alternatively, if the measure data has been collected for multiple twelve month periods—such as for 24 months, 36 months, 48 months, 60 months, or 72 months—the measure data can be cumulatively consolidated into twelve month periods and displayed in a bar graph, with each bar showing the year end measure data at the end of a single 12 month period. For example, if measure data had been collected for 48 months, a bar graph having four bars would be displayed, each bar showing the year end measure data at the end of the 12^{th} month, at the end of the 24^{th} month, at the end of the 36^{th} month, and at the end of the 48^{th} month.

### I. SETTING UP THE CLAIMED METHOD IN EXCEL

Claimed method 10 may be embodied in many different computer programs. In one embodiment, claimed method 10 is set up in a Microsoft Excel spreadsheet (hereinafter “Excel”). Excel is a program that has worksheets within a program window. A worksheet is a coherent cell-coordinate system. One of ordinary skill in the art of data analysis will have the knowledge to set up and use claimed method 10 in an Excel spreadsheet. Books that can be used by those of ordinary skill in the art to reference the necessary Excel terms and usage include: (1) Etheridge, Denise. Micosoft Excel Data Analysis. 3^{rd} Edition. Indianapolis, Ind.: Wiley Publishing, Inc., 2010; and (2) Harvey, Greg. Microsoft Excel 2010 for Dummies. Hoboken, N.J.: Wiley Publishing, Inc., 2010.

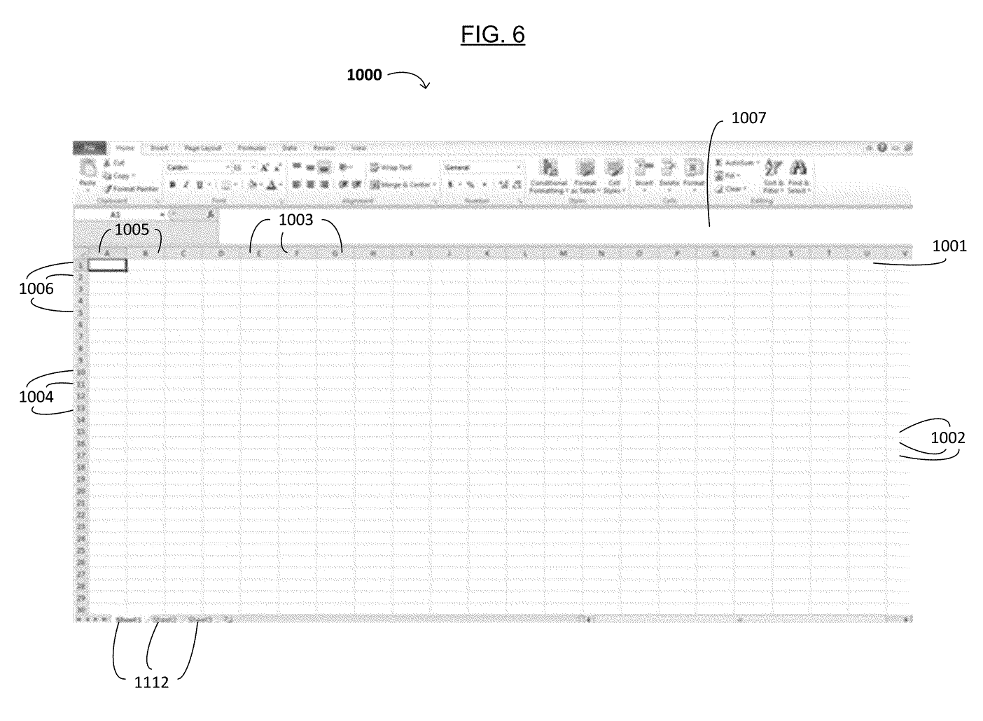

As shown in FIG. 6, for Excel program 1000 that carries out claimed method 10, there may be a multiplicity of worksheets 1001, each worksheet 1001 containing a plurality of cells 1002, each cell 1002 identified by a column 1003 and a row 1004. Each column 1003 is identified by column heading 1005 labeled by a letter such as “A,” “B,” “C,” etc. Each row 1004 is identified by row heading 1006 labeled by a number such as “1,” “2,” “3,” etc. Each cell 1002 is identified by its column heading 1005 and its row heading 1006. The cell in the upper left hand corner of worksheet 1001 is identified as “A1,” which are its cell coordinates.

Formula bar 1007 displays the contents of that cell. To enter data into any cell 1002, a user selects the cell, enters the data into formula bar 1007 and presses “Enter.” Either text and/or numbers may be entered into any cell 1002. Excel allows the association of the contents of any cell 1002 with its column 1003 and its row 1004. If the number “4” is entered in the cell in the upper left hand corner of the worksheet 1001, then the number “4” is associated with the cell identified as “A1.”

Formula bar 1007 can also formulate calculations for the content of any cell 1002. A cell 1002 may be used to display the calculated result of data from other cells 1002. For example, cell C5 may have the following formula entered: “=C2-C4.” Then, cell C5 would display the calculated result of the content of cell C4 subtracted from the content of cell C2. Excel can carry out all of the following mathematical functions, individually and in combination: addition, subtraction, multiplication, and division.

As shown in FIG. 6, multiple worksheets 1001 can be linked. A second worksheet and a third worksheet can be linked to a first worksheet. The sheet tabs 1112 at the bottom of FIG. 6 can be selected to move from one worksheet to another, as the user desires. Each worksheet 1001 can be named as the user wishes. Cells in different worksheets can be linked to each other. If a first worksheet, cell C2 needs to show a result that is half the content of second worksheet, cell A1, then the user would selected first worksheet, cell C2 and enter in the formula line 1007: “=′second worksheet′ !A1/2.”

To carry out claimed method 10, an Excel program 1000 needs to be set up with five separate and linked worksheets: Measure Definitions Worksheet 2000, Data Entry Worksheet 3000, Dashboard Worksheet 4000, Graphical Summary Worksheet 5000, and Historical Record Worksheet 6000. Sheet tabs appear at the bottom of each of the worksheets to allow the user to select the desired linked worksheet.

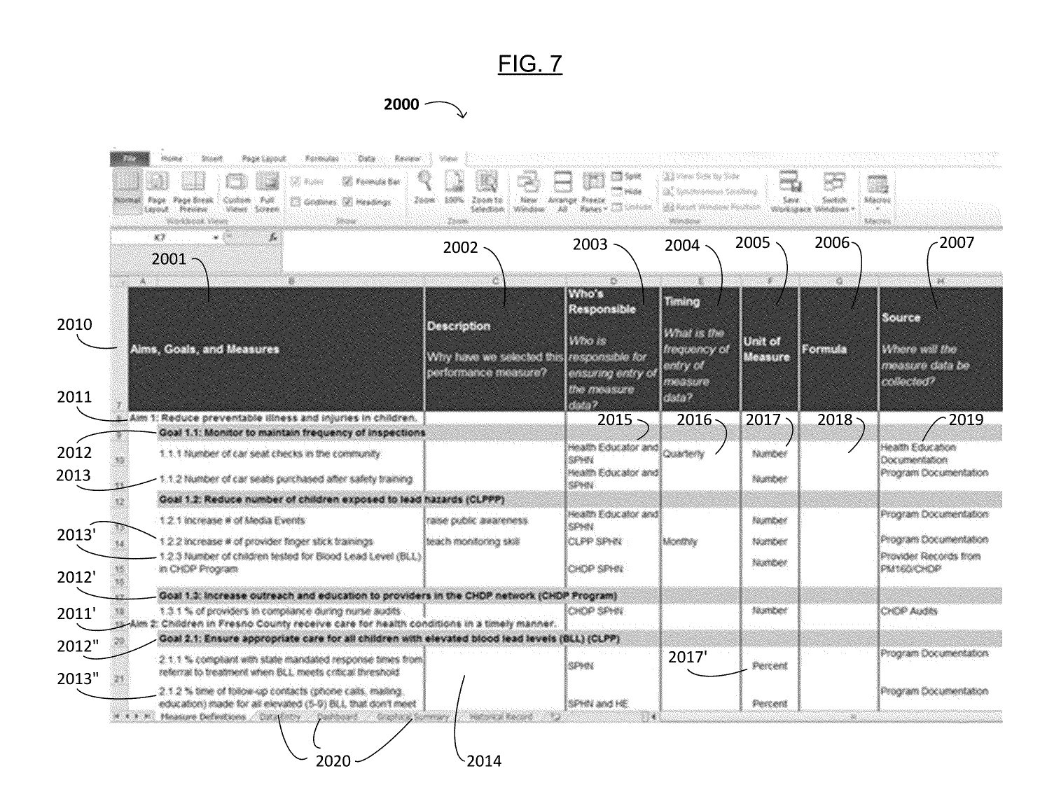

As shown in FIG. 7, to carry out claimed method 10 there must be a Measure Definitions Worksheet 2000. In Measure Definitions Worksheet 2000, listing step 100, determining step 200, defining step 200, describing step 310, naming step 320, specifying step 330, labeling step 340, stating step 350, documenting step 360 demarcating step 500, and demarcating step 550 are all carried out. Aims, goals, and performance measures are entered in column 2001. The descriptions of the performance measure are all entered in column 2002. The names or positions of the person responsible for ensuring entry of the measure data are entered in column 2003. The timing or frequency of entering the measure data are recorded in column 2004. The units of measure labeling the appropriate measure data are recorded in column 2005. The formula for documenting protocols and experiments for collecting measure data are recorded in column 2006. The source for collection of performance measure data is recorded in column 2007.

Heading row 2010 shows the column titles for column 2001, column 2002, column 2003, column 2004, column 2005, column 2006 and column 2007. In heading row 2010, column 2001 has column title “Aims, Goals, and Measures.” Each column has its own Excel column coordinate identified by an English alphabet letter. In heading row 2010, column 2002 has column title “Description.” In one embodiment, heading row 2010, column 2002 may also include the phrase “Why have we selected this measure?” to prompt the user to describe the reason for selecting the particular performance measure in defining step 300. In heading row 2010, column 2003, has column title “Who's Responsible.” In one embodiment, heading row 2010, column 2003 also may include the phrase “Who is responsible for ensuring entry of the measure data?” In heading row 2010, column 2004 has column title “Timing.” In one embodiment, heading row 2010, column 2004 also may include the phrase “What is the frequency of entering the measure data?” In heading row 2010, column 2005 has column title “Unit of Measure.” In heading row 2010, column 2006 has column title “Formula.” In heading row 2010, column 2007 has column title “Source.” In one embodiment, heading row 2010, column 2007 also may include the phrase “Where will the measure data be collected?”

As shown in FIG. 7, listing step 100 is carried out when the user enters an aim in an aim row 2011 under column 2001. Each aim row 2011 has its own Excel row coordinate identified by a number. There may be multiple aim rows 2011, each one containing an entered aim. Each aim is chosen to advance some organizational priority. The organizational priority is not entered in Measure Definitions worksheet 2000. As shown in FIG. 7, two examples of aims to be entered in separate aim rows 2011 may be: (1) “Aim 1: Reduce preventable illness and injury in children,” and (2) “Aim 2: Children in Fresno County receive care for health conditions in a timely manner.” Each aim entered in one of aim rows 2011 will be numbered “Aim 1,” “Aim 2,” “Aim 3,” through “Aim N.” There may be an infinite number of aims entered in aim rows 2011 under column 2001 for claimed method 10.

As shown in FIG. 7, determining step 200 is carried out when the user enters a goal in a goal row 2012 under column 2001. Each goal row 2012 has its own Excel row coordinate identified by a number. There may be multiple goal rows 2012, each one containing an entered goal the user determines is necessary to reach in order to achieve an aim. For example, to achieve “Aim 1: Reduce preventable illness and injuries in children,” a user may enter three goals: (1) Goal 1.1: Monitor to maintain frequency of inspections, (2) Goal 1.2:

Reduce number of children exposed to lead hazards, and (3) Goal 1.3: Increase outreach and education to providers in the CHDP network.” Each goal entered in one of goal rows 2012 to help achieve Aim 1 will be numbered “Goal 1.1, “Goal 1.2,” Goal 1.3,” through Goal 1.N.” There may be an infinite number of goals entered for each aim. In a preferred embodiment, goal rows 2012 are shaded and the content indented so the user can easily see the different goal rows 2012 under each of aim rows 2011.

Also as shown in FIG. 7, defining step 300 is carried out when the user enters a performance measure in a measure row 2013 under column 2001. Each measure row 2013 has its own Excel row coordinate identified by a number. There may be multiple measure rows 2013, each one containing an entered performance measure the user determines is necessary to measure attainment of the corresponding goal. For example, to measure attainment of “Goal 1.1: Monitor to maintain frequency of inspections,” a user may enter two performance measures: (1) “1.1.1 Number of car seat checks in the community,” and (2) “1.1.2 Number of car seats purchased after safety training.” Each performance measure entered in one of measure rows 2013 to measure attainment of Goal 1.1 will be numbered “1.1.1,” 1.1.2,” 1.1.3,” through 1.1.N.” There may be an infinite number of performance measures entered for each goal.

As shown in FIG. 7, describing step 310 is carried out when the user enters a description in a description cell 2014 that describes why the performance measure was selected to measure attainment of its goal. Each description cell 2014 will be under column 2002, and will be in one of measure rows 2013.

As shown in FIG. 7, naming step 320 is carried out when the user enters the name or position title of the person responsible for ensuring entry of the measure data for each performance measure in a name cell 2015. Each name cell 2015 will be under column 2003, and will be in one of measure rows 2013.

As shown in FIG. 7, specifying step 330 will be carried out when the user enters the timing or frequency of measure data entry in a frequency cell 2016. Specifying step 330 entries may be one of: monthly, quarterly, biannually, or annually. Each frequency cell 2016 will be under column 2004, and will be in one of measure rows 2013.

As shown in FIG. 7, labeling step 340 will be carried out when the user enters the unit of measure for each measure data in a unit cell 2017. In one embodiment, shown in FIG. 7, each unit cell 2017 may be programmed to contain a drop down menu containing the following units: number, percentage, and dollar. Each unit cell 2017 will be under column 2005 and will be in one of measure rows 2013.

As shown in FIG. 7, documenting step 360 will be carried out when the user enters the protocols for collecting measure data from the source in protocol cell 2018. Each protocol cell 2018 will be under column 2006 and will be in one of measure rows 2013.

As shown in FIG. 7, stating step 350 will be carried out when the user enters the collection source for each measure data in source cell 2019. Each source cell 2019 will be under column 2007 and will be in one of measure rows 2013.

As shown in FIG. 7, on the bottom of Measure Definitions worksheet 2000, there are sheet tabs 2020 to the four other linked worksheets: Data Entry Worksheet 3000, Dashboard worksheet 4000, Graphical Summary worksheet 5000, and Historical Record worksheet 6000. A user can access any of the other four linked worksheets by clicking on the corresponding sheet tab 2020.

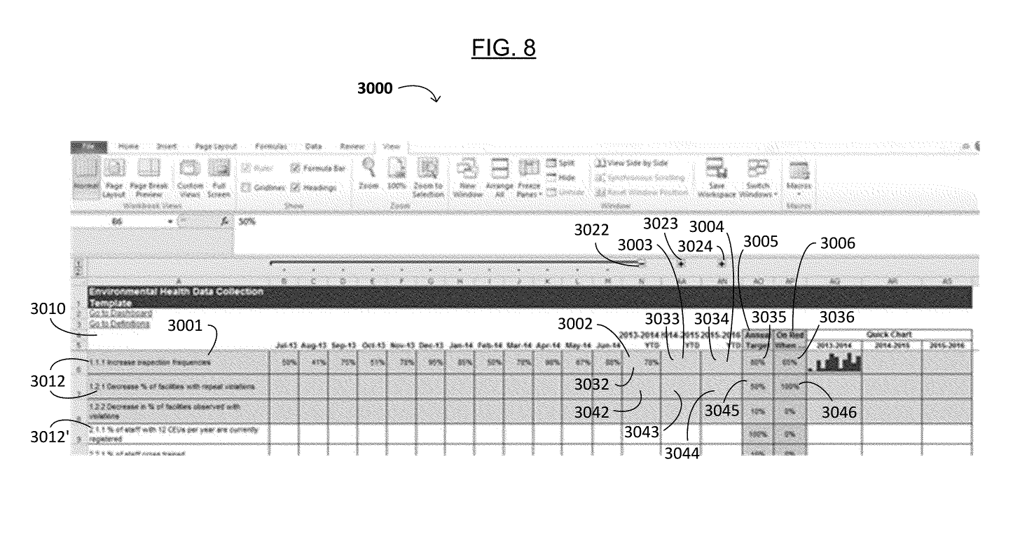

As shown in FIG. 8, claimed method 10 must have a Data Entry worksheet 3000 in order to allow the user to enter measure data into the Excel spreadsheet carrying out the method. Data Entry worksheet 3000 has column 3001 listing all performance measures. Also, Data Entry worksheet 3000 has column 3002 showing year to date measure data from one twelve month period for each performance measure, column 3003 showing year to date measure data from a second twelve month period for each performance measure, and column 3004 showing year to date measure data from a third twelve month period for each performance measure. Column 3002 can be expanded to show 12 monthly entry cells if the user clicks on expansion tab 3022. (FIG. 9 shows the expanded column 3002.) Column 3003 can be expanded to show 12 monthly entry cells if the user clicks on any of expansion tabs 3023. Column 3004 can be expanded to show 12 monthly entry cells if the user clicks on expansion tab 3024.

Also, Data Entry worksheet 3000 includes target column 3005 for a user to enter the annual target for the measure data for each performance measure, and red line column 3006 for the user to enter the red line target for the measure data for each performance measure.

Heading row 3010 shows the column titles for column 3002, column 3003, column 3004, column 3005, and column 3006. For column 3002, the user can enter in heading row 3010 any heading label for a twelve month period, for example: Year 1, First Year, 2013, or 2013-14. Preferably, the heading label in heading row 3010 corresponds to the Roman numeral designation of a year or years, such as 2013 or 2013-14. For column 3003, the user can enter in heading row 3010 any label for a twelve month period that indicates that it is one year later than the heading label entered for column 3002, for example: Year 2, Second Year, 2014, or 2014-15. For column 3004, the user can enter in heading row 3010 any label for a twelve month period that indicates that it is two years later than the heading label entered for column 3002, for example: Year 3, Third Year, 2015, or 2015-16.

As shown in FIG. 8, in column 3001, all performance measures entered in Measure Definitions worksheet 2000 are displayed in separate measure rows 3012. All measure rows 2012 from Measure Definitions worksheet 2000 are linked into separate measure rows 3012 in Data Entry worksheet 3000. A user can reference Harvey, Greg. Microsoft Excel 2010 for Dummies. 2010. Pages 145-174, 229-252, for instructions on how to copy and paste from different worksheets, as well as how to maintain and work within and between multiple worksheets.

As shown in FIG. 8, for each measure definition entered in column 3001, rows 3012, the first year's year to date measure data will be manually entered by a user according to the frequency specified in specifying step 330, in FIG. 7, column 2004, in column 3002, in the corresponding measure row 3012. The timely entry will be ensured by the person named in naming step 320, whose name or position title is entered in FIG. 7, column 2003 in the corresponding measure row 2012. For each measure definition, the year to date measure data may be entered once, and updated once, twice, or multiple times.

For example, as shown in FIG. 8, for the performance measure labeled 1.1.1, the user will enter the year to date measure data at the specified time for the first year in cell 3032. For the performance measure labeled 1.1.1, the user will enter the year to date measure data at the specified time for the second year in cell 3033. For the performance measure labeled 1.1.1, the user will enter the year to date measure data at the specified time for the third year in cell 3034.

For additional examples, as shown in FIG. 8, for the performance measure labeled 1.2.1, the user will enter the year to date measure data at the specified time for the first year in cell 3042. For the performance measure labeled 1.2.1, the user will enter the year to date measure data at the specified time for the second year in cell 3043. For the performance measure labeled 1.2.1, the user will enter the year to date measure data at the specified time for the third year in cell 3044.

Also as shown in FIG. 8, the user enters the annual target for each performance measure in column 3005 in the cell in the corresponding row 3012. The user enters the red line target for each performance measure in column 3006. For example, for performance measure 1.1.1, the user will enter the annual target number for the performance measure 1.1.1 measure data in cell 3035. For performance measure 1.1.1, the user will enter the red line target number for the performance measure 1.1.1 measure data in cell 3036. For performance measure 1.2.1, the user will enter the annual target number for the performance measure 1.2.1 measure data in cell 3045. For performance measure 1.2.1, the user will enter the red line target number for the performance measure 1.2.1 measure data in cell 3046.

In one embodiment, column 3005 can be shown in green to remind user that the dashboard will show the color green for a performance measure when the year to date measure data reaches the annual target number. Column 3006 can be shown in red to remind the user that the dashboard will show the color red for a performance measure when the year to date measure data has not reached the red line target number.

As shown in FIG. 8, for the performance measure labeled 1.2.1, the user will enter and update the year to date measure data at the specified time for the first year in cell 3042. For the performance measure labeled 1.2.1, the user will enter and update the year to date measure data at the specified time for the second year in cell 3043. For the performance measure labeled 1.2.1, the user will enter and update the year to date measure data at the specified time for the third year in cell 3044.

As shown in FIGS. 8 and 9, Data Entry sheet 3000 can be programmed so that each of column 3002, column 3003, and column 3004 can expand to reveal 12 columns, each column designed to hold measure data for one month of the calendar year. As shown in FIG. 8, when columns 3002-3004 are not expanded, the tabs 3022-3024 each have a plus sign on each one. When the user clicks on each of tabs 3022-3024 when they have the plus sign showing, the tabs 3022-3024 change to show a minus sign on each tab. Also, when the user clicks on the tabs 3022-3024 when they have the plus sign showing, each of the columns 3002-3004 expand to show 12 columns each. Each one of columns 3002-3004 can be expanded individually one at a time, or all together at the same time.

For example, in FIG. 9, when the user clicks on the “plus sign” on tab 3022, column 3002 can expand to include: expanded column 3050, expanded column 3051, expanded column 3052, expanded column 3053, expanded column 3054, expanded column 3055, expanded column 3056, expanded column 3057, expanded column 3058, expanded column 3059, expanded column 3060, and expanded column 3061. Heading row 3010 will have headings for each of the expanded columns 3050-3061 including a month and a year designation. In one example, the heading in heading row 3010 for expanded row 3050 may be “Jul 13” corresponding to July 2013.

As shown in FIG. 9, when each of columns 3002-3004 are expanded, there are twelve columns to hold measure data for each performance measure entered in each of measure rows 3012. The measure data entered in the twelve expanded columns for each performance measure can either be the year-to-date measure data, or only the measure data for the time period. The year to date measure data in column 3002, column 3003, and/or column 3004 may need to be independently calculated and entered.

For example, as shown in FIG. 9, for the performance measure labeled 1.1.1, if the specifying step specified that the year to date data would be entered monthly, then the user may enter the year to date measure data as of the first month in cell 3085, the year to date measure data as of the second month in cell 3086, the year to date measure data as of the third month in cell 3087, the year to date measure data as of the fourth month in cell 3088, the year to date measure data as of the fifth month in cell 3089, the year to date measure data as of the sixth month in cell 3090, the year to date measure data as of the seventh month in cell 3091, the year to date measure data as of the eighth month in cell 3092, the year to date measure data as of the ninth month in cell 3093, the year to date measure data as of the tenth month in cell 3094, the year to date measure data as of the eleventh month in cell 3095, and the year to date measure data as of the twelfth month in cell 3096. Also, for performance measure 1.1.1, the user will need to enter the most recent year to date measure data for the twelve month period depicted by “2013-14” in cell 3032.

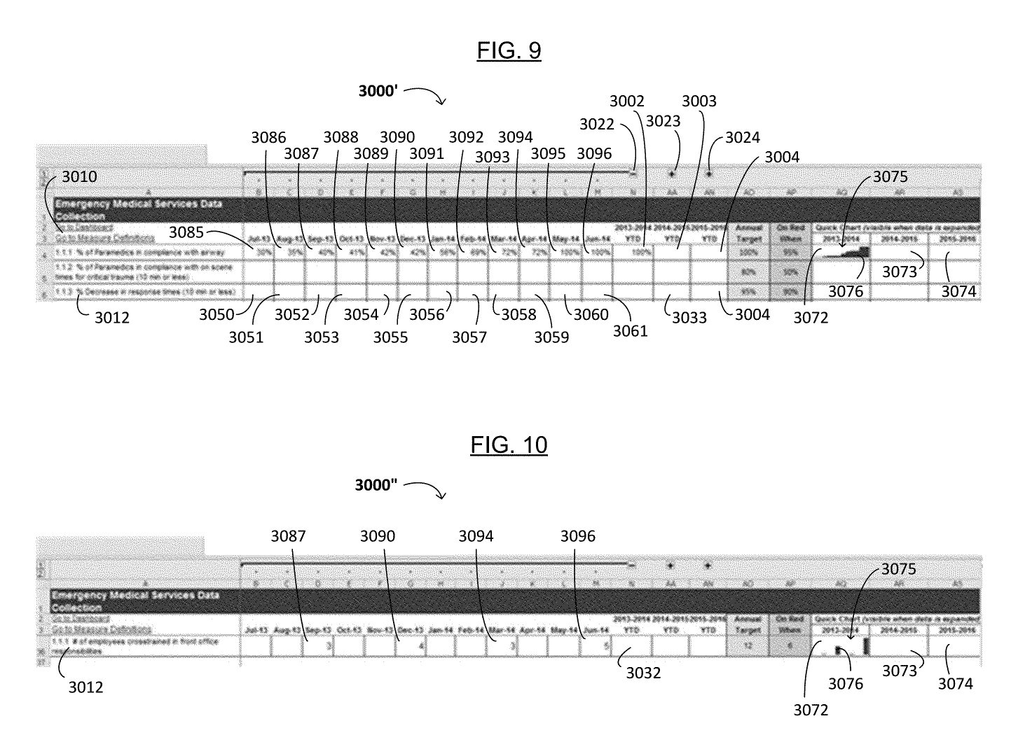

Alternatively, for any performance measure, the user can also choose to enter the data for only a specific month, or a specific quarter, or a specific six month period. As shown in FIG. 10, for the performance measure labeled 1.1.1, if the specifying step specified that the year to date data would be entered quarterly, then the user may enter the first quarter measure data in cell 3087, the second quarter measure data in cell 3090, the third quarter measure data in cell 3093, and the fourth quarter measure data in cell 3096.

As shown in FIGS. 9 and 10, when a performance measure has measure data in one or more expanded cells, then claimed method 10 may show spark chart 3075 to track progression of measure data entered in the expanded cells. For example, in FIG. 9, performance measure 1.1.1 has year to date measure data entered in each of cells 3085-3096—because the specified frequency for measure data entry was “monthly”—and spark chart 3075 shows bar graph 3076 tracking the progression of the year to date measure data for each month in which measure data was entered. In FIG. 10, performance measure 1.1.1 has measure data in cell 3087, cell 3090, cell 3093, and cell 3096. Each of cell 3087, cell 3090, cell 3093, and cell 3096 contains only the data entered for that specific quarter. As shown in FIG. 10, spark chart 3075 shows only four bars, one bar for one of the expanded cells for which measure data is entered. The measure data entered in each of cell 3087, cell 3090, cell 3093 and cell 3096 are not year to date measure data. As shown in FIG. 10, for performance measure 1.1.1, the user enters the year to date measure data in cell 3032.

Spark chart 3075 in the form of bar graph 3076 may be displayed for any performance measure in rows 3012 for any twelve month period indicated in row heading 3010. As shown in FIGS. 9 and 10, cell 3072 may show spark chart 3075 in the form of bar graph 3076 for performance measure 1.1.1, for the twelve month period 2013-14. Cell 3073 may show spark chart 3075 in the form of bar graph 3076 for performance measure 1.1.1, for the twelve month period 2014-15. As shown in FIGS. 9 and 10, cell 3074 may show spark chart 3075 in the form of bar graph 3076 for performance measure 1.1.1, for the twelve month period 2015-16.

One of ordinary skill in the art knows how to display Excel worksheet data in the form of bar graphs. Etheridge (2010), pages 186-211, discusses how to create charts and graphs, including spark charts and bar graphs.

### J. DASHBOARD

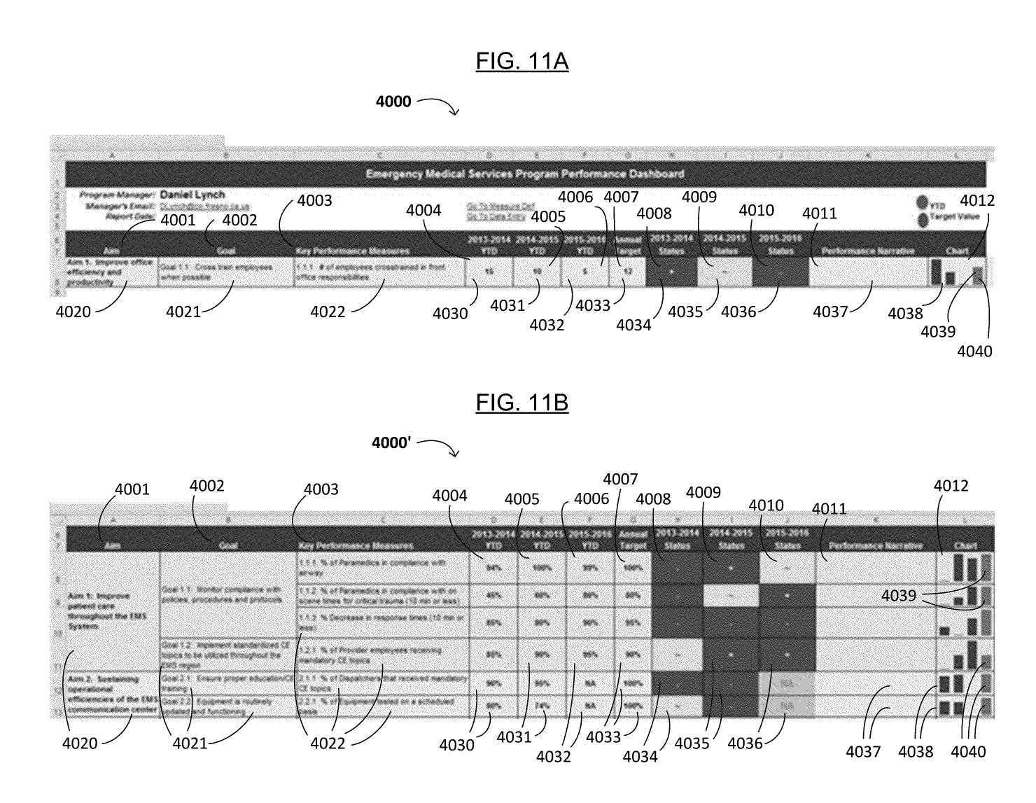

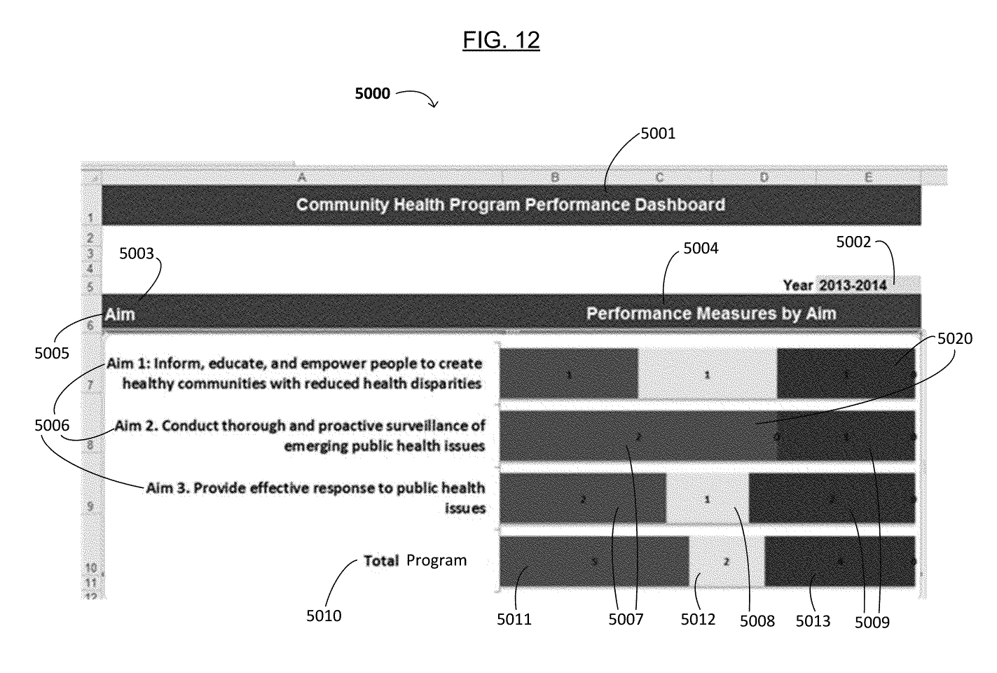

A dashboard carries out calculating step 600 and displaying step 700. As shown in FIGS. 11A and 11B, Dashboard worksheet 4000 may link to Measure Definitions worksheet 2000 and Data Entry worksheet 3000. As shown in FIGS. 11A and 11B, Dashboard worksheet 4000 may have aim column 4001, goal column 4002, and performance measure column 4003. There may be aim row 4020, goal row 4021, and performance measure row 4022. The aims will each be linked and copied from Measure Definitions worksheet 2000, column 2001, aim rows 2011.

Column 4004 shows the year to date measure data or year end measure data for the first twelve month period. Column 4005 shows the year to date measure data or the year end measure data for the second twelve month period. Column 4006 shows the year to date measure data or the year end measure data for the third twelve month period. The year to date measure data and the year end measure data are linked from Data Entry worksheet 3000.

The goals may each be linked and copied from Measure Definitions worksheet 2000, column 2001, goal rows 2012. The performance measures may each be linked and copied from Measure definitions worksheet 2000, column 2001, performance measure rows 2013. For each performance measure, the year end measure data at the end of each twelve month period may be linked and copied from Data Entry worksheet 3000 from column 3002, column 3003, and column 3004. The annual target number is linked and copied from Data Entry worksheet 3000 from column 3005. The red line target number is linked and copied from Data Entry worksheet 3000 from column 3006. Dashboard worksheet 4000 also has status columns 4008-4010, narrative column 4011, and chart column 4012.

The Dashboard worksheet 4000 displays a color-coded alert system showing how the year to date measure data or the year end measure data for each performance measure relates to the red line target number and the annual target number entered in Data Entry worksheet 3000. Cells in status column 4008 show—for each performance measure—how the year to date measure data or the year end measure data from the first twelve month period, from column 4004, relates to the red line target number entered in and linked from Data Entry worksheet 3000, column 3005 and annual target, from Data Entry worksheet 3000, column 3006. Cells in status column 4009 show—for each performance measure—how the year to date measure data or the year end measure data from the second twelve month period, from column 4005, relates to the red line target number, entered in and linked from Data Entry worksheet 3000, column 3005 and annual target number, entered in and linked from Data Entry worksheet 3000, column 3006. Cells in status column 4010 show—for each performance measure—how the year to date measure data or the year end measure data from the third twelve month period, from column 4006, relates to the red line target, entered in and copied from Data Entry worksheet 3000, column 3005 and annual target, entered in and copied from Data Entry worksheet 3000, column 3006.

As shown in FIG. 11A, for performance measure 1.1.1, the year to date or year end measure data for year 2013-14 is linked and copied from Data Entry worksheet 3000, cell 3022, into Dashboard worksheet 4000, cell 4030. If the numerical entry in cell 4030 does not exist, then status cell 4043—showing status of performance measure 1.1.1—will show “NA” for “not available” to alert the user that there is no year to date or year end measure data entered for this performance measure.

As shown in FIG. 11A, for performance measure 1.1.1, if the number in cell 4030 does not exceed its red line target, then status cell 4034 will show the color red with a “−” sign. If the number in cell 4030 exceeds its red line target, but is less than its annual target, then status cell 4034 will show the color yellow with a “˜” sign. If the number in cell 4030 meets or exceeds its annual target (as linked into cell 4033), then status cell 4034 will show the color green with a “+” sign. From looking at the colors in status cells in the status columns 4008-4010, the user knows the status of each performance measure for each goal and each aim.

As shown in FIG. 11A, the year end measure data entered in cell 4030 is greater than the annual target in cell 4033, so status cell 4034 will show the color green with a “+.” The year end measure data entered in cell 4031 is less than the annual target in cell 4033, but greater than the red line target as previously entered, so status cell 4035 will show the color yellow with a “˜.” The year end measure data entered in cell 4032 is less than the annual target in cell 4033, and less than the red line target as previously entered, so status cell 4036 will show the color yellow with a “˜.” The user can enter an explanation for the measure data progression for each performance measure in narrative cell 4037 in column 4011.

In FIG. 11A, for the performance measure labeled 1.1.1, column 4012 shows spark chart 4039 as bar graph 4040 to track the progression of the year to date measure data in each of the three twelve month periods. Chart cell 4038 may show a bar graph 4040 having four columns, the first three columns show a graphical representation of the year to date data for each of the three twelve month periods, and the fourth column is a graphical representation of the annual target shown in column 4007. For each bar graph 4040, the first three bars may be a different color than the fourth bar.

As shown in FIG. 11B, Dashboard worksheet 400 may show multiple aims, multiple goals, and multiple performance measures. The multiple aims may be each linked from and copied from one of Measure Definitions worksheet 2000, aim rows 2011 (FIG. 7) and linked into and copied into one of Dashboard worksheet 4000, aim rows 4020 (FIG. 11B). The multiple goals may be each linked from and copied from one of Measure Definitions worksheet 2000, goal rows 2011 (FIG. 7) and linked into and copied into one of Dashboard worksheet 4000, goal rows 4021 (FIG. 11B). The multiple performance measures may be each linked from and copied from one of Measure Definitions worksheet 2000, performance measures rows 2013 (FIG. 7) and linked into and copied into one of Dashboard worksheet 4000, performance rows 4022.

As shown FIG. 11B, the year to date measure data or year end measure data for each performance measure for a first twelve month period will be linked into one of cells 4030. For each performance measure, one of corresponding status cells 4034 will show in a color coded alert when the year to date measure data or year end measure data entered in one of cells 4030 meets the corresponding annual target entered in one of target cells 4033. The year to date measure data or the year end measure data for each performance measure for a second twelve month period will be entered in one of cells 4031. For each performance measure, one of corresponding status cells 4035 will show in a color coded alert whether the year to date measure data or year end measure data entered in one of cells 4031 meets the corresponding annual target entered in one of target cells 4033. The year to date measure data for each performance measure for a third twelve month period will be entered in one of cells 4032. For each performance measure, one of corresponding status cells 4036 will show in a color coded alert whether the year to date measure data or year end measure data entered in one of cells 4032 meets the corresponding annual target entered in one of target cells 4033.

As shown in FIG. 11B, if for any performance measure, a cell 4030, a cell 4031, and a cell 4032 contains year to date measure data or year end measure data, then a chart cell 4038 will show spark chart 4039 as bar graph 4040, displaying a graphical representation of the year to date measure data or the year end measure data entered in corresponding cells 4030, 4031, and 4032. The last bar of bar graph 4040 will be the annual target number entered in the corresponding target cell 4033. Bar graph 4040 may be color referenced so that the first three bars are a different color from the last bar.

### K. GRAPHICAL SUMMARY

As shown in FIG. 12, claimed method 10 may also include a Graphical Summary worksheet 5000 that shows for each aim how many performance measures have met their annual targets. Graphical Summary worksheet 5000 may be called the Program Performance Dashboard.

For each Graphical Summary worksheet 5000, there may be program heading 5001 to identify the organizational program, office or department using claimed method 10. Time period heading 5002 shows which twelve month period is depicted in Graphical Summary worksheet 5000. Aim column 5003 will list the aim or aims for the organizational program identified in program heading 5001. For each aim, graphical summary column 5004 will show graphical summary 5020, summarizing how many performance measures have green color coded alerts, how many performance measures have yellow color coded alerts, and how many performance measures have red color coded alerts. Heading row 5005 contains text to identify the aims in aim column 5003 and to explain that there is a summary of the performance measures by aim.

Aims listed in aim column 5003 are each individually listed in aim rows 5006. The content of each aim row 5006 are linked from and copied from a corresponding Measure Definitions worksheet 2000, aim row 2011 (FIG. 7). For each aim listed in an aim row 5006, graphical summary 5020 will summarize the number of performance measures for each aim, and the number of performance measures having year to date measure data that meet or exceed their annual target, the number of performance measures having year to date measure data that are under their red line target, and the number of performance measures having year to date measure data that are between their red line target and their annual target.

As shown in FIG. 12, for each aim listed in an aim row 5006 and in an aim column 5003, graphical summary 5020 may show green section 5007 with a number corresponding to the number of performance measures that are currently receiving a color-code alert of “green”—indicating year to date measure data currently exceeding the assigned annual target. Also, for each aim listed in an aim row 5006 and in an aim column 5003, graphical summary 5020 may show yellow section 5008 with a number corresponding to the number of performance measures that are currently receiving a color-code alert of “yellow”—indicating year to date measure data currently exceeding the red line target but not meeting the annual target. Also, for each aim listed in an aim row 5006 and in an aim column 5003, graphical summary 5020 may show red section 5009 with a number corresponding to the number of performance measures that are currently receiving a color-code alert of “red”—indicating year to date measure data currently does not the exceed the red line target.

Graphical summary worksheet 5000 may have program graphical summary line 5010 showing a graphical representation of the status of all performance measures for all aims in the identified program. Program graphical summary line 5010 may include green section 5011 showing the number of performance measures in the program that are currently receiving a color-code alert of “green”—indicating year to date measure data currently exceeding the assigned annual target. Program graphical summary line 5010 may include yellow section 5012 showing the number of performance measures in the department that are currently receiving a color-code alert of “yellow”—indicating year to date measure data currently exceeding the red line target but not meeting the annual target. Department graphical summary line 5010 may include red section 5013 showing the number of performance measures in the department that are currently receiving a color-code alert of “red”—indicating year to date measure data that does not currently exceed the red line target.

Graphical summaries 5020 are created by calculations embedded into Graphical summary worksheet 5000 using year to date measure data entered in Data Entry worksheet 3000 and comparing the year to date measure data to their corresponding annual target and their corresponding red line target. The status of each performance measure based on its year to date measure data is determined individually. Then the status of all performance measures supporting one single aim are collectively displayed in an aim row 5006, each performance measure depicted in one of sections 5007, 5008, or 5009. Program graphical summary line 5010 summarizes the status of all performance measures in an identified program.

Comparing Excel data and creating Excel graphical summaries are described in Etheridge, 2010. Pages 58-78, 186-211.

### L. AGENCY OR DEPARTMENT LEVEL DASHBOARD

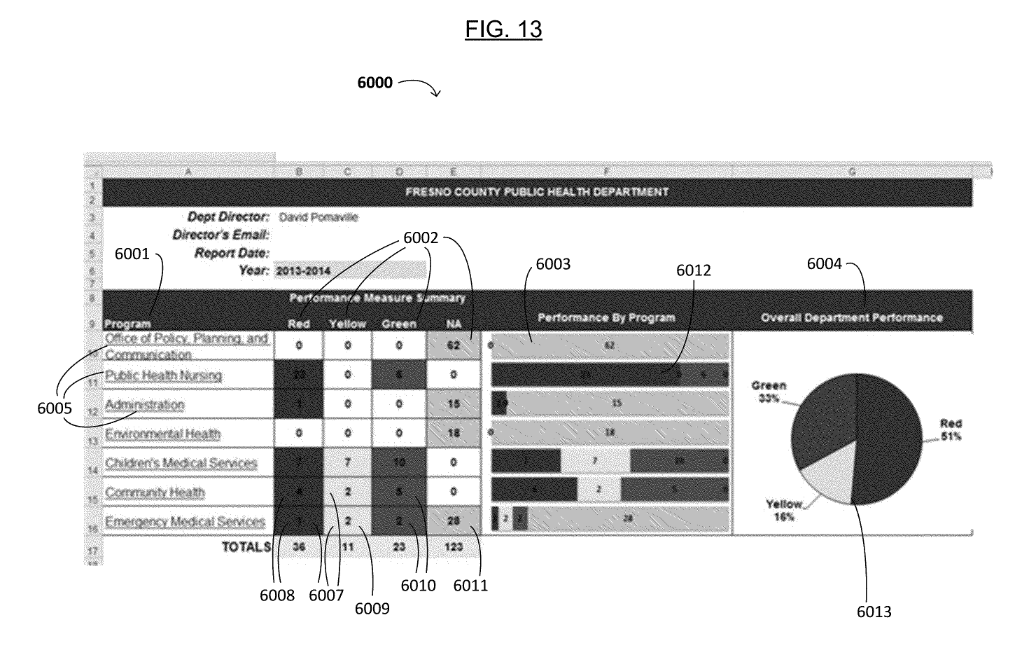

As shown in FIG. 13, there may be a high level dashboard that links from and pulls in data from all individual program worksheets to create an agency or department level dashboard. If a department issues claimed method 10 in Excel spreadsheet form to multiple programs, then each program will have its own identified Measure Definitions worksheet 2000, its own Data Entry worksheet 3000, its own Dashboard worksheet 4000, and its own Graphical Summary worksheet 5000. Department Dashboard 6000 shows the status of all performance measures for each program under the department.

The Department Dashboard 6000 may have program column 6001, performance measure summary columns 6002, performance chart column 6003, and department performance column 6004. Each of program rows 6005 link from the program identification information from the individual program worksheets, such as from Graphical Summary 5000, program heading 5001 (FIG. 12). All programs in a department, that used claimed method 10 in an Excel format, individually are listed in program rows 6005. Then the status of program performance measures may be displayed in three different ways. Department Dashboard 6000 may include one, two, or all three of these displays.

Performance measure summary columns 6002 display performance measure status in cells 6007, each cell 6007 showing the number of performance measures having a certain status. Cells 6008 show the number of a program's performance measures receiving a red color-coded alert—“—indicating year to date measure data that does not currently exceed the red line target. Each cell 6008 may be shaded with the color red. Cells 6009 show the number of a program's performance measures receiving a yellow color-coded alert—”—indicating year to date measure data that currently exceeds red line target but does not meet annual target. Each cell 6009 may be shaded with the color yellow. Cells 6010 show the number of a program's performance measures receiving a green color-coded alert—“—indicating year to date measure data that currently meets or exceeds the annual target. Each cell 6010 may be shaded with the color green. Cells 6011 may indicate which performance measures have no year to date measure data entered for the current year.

Performance chart column 6003 may contain a visual reference 6012 for each program's performance measures. For each program, visual reference 6012 may summarize the numbers and status shown in cells 6007, showing the proportionality of performance measures color coded red, color coded yellow, color coded green, and not available.

Department performance column 6004 may contain a graphical representation of the performance measures of the entire department or agency. In one embodiment, the department level graphical representation may be pie chart 6013, showing on a department level, the percentage of performance measures being color-coded green, the percentage of performance measures being color coded yellow, and the percentage of performance measures being color coded red.

### M. INSTALLING THE CLAIMED METHOD INTO AN AGENCY'S SYSTEM

An Excel spreadsheet set up with the worksheets as shown and described in FIGS. 6-13 can be installed into any department or agency's computers. One department may need several program level worksheets 1000, 2000, 3000, 4000, and 5000 for its many different programs.

All program worksheets can be created and saved onto a zip file. The department wanting access to all programs worksheets will extract the zipped Excel program files and save those files onto the computer or system that a department user will use to look at Department Dashboard 6000. The department will then create Excel shortcuts for each program to access the right program worksheets. The department will send out the shortcuts to each program via email. The program user will click on the shortcut link to activate the shortcut.

Linking, automating and sharing Excel workbooks and spreadsheets are described Harvey, 2010. Pages 345-360; and Etheridge, 2010. Pages 256-275.

### N. ADDRESSING ISSUES RAISED BY AFFORDABLE CARE ACT

By implementing the claimed method, preferably in an Excel spreadsheet, the department or agency can show progress towards achieving department or agency aims. This is necessary under the Affordable Care Act because currently, Public Health Accreditation is voluntary; however, it is widely known that soon accreditation will become mandatory. Public Health Accreditation promotes the measurement of health department performance against a set of nationally recognized, practice-focused and evidenced-based standards. At this point in time, the goal of the voluntary national accreditation program is to improve and protect the health of the public by advancing the quality and performance of Tribal, state, local, and territorial public health departments.

The health department accreditation process seeks to advance quality and performance within public health departments. Accreditation standards define the expectations for all public health departments that seek to become accredited. National public health department accreditation has been developed because of the desire to improve service, value, and accountability to stakeholders. The tangible benefits of working on accreditation will vary among health departments. Since accreditation is about performance and quality improvement, the actual benefits to a health department will depend on its identified needs. Accreditation provides a framework for a health department to identify performance improvement opportunities, to improve management, develop leadership, and improve relationships with the community. The process is one that will challenge the health department to think about what business it does and how it does that business.

A number of embodiments of the invention have been described. Nevertheless, it will be understood that various modifications may be made without departing from the spirit and scope of the invention. Accordingly, other embodiments are within the scope of the present invention.

We claim:

1. A management method to achieve organizational aims, comprising:
listing organizational aims;
determining one or more goals to meet in order to reach each of said organizational aims;
defining one or more performance measures each having numeric year to date measure data to measure attainment of each of said goals in a twelve month period;
describing why each of said performance measures was chosen for measuring attainment of said goal;
naming person or personnel position responsible for ensuring entry and update of said year to date measure data for each of said performance measures;
specifying frequency of said entry and said update of said year to date measure data for each of performance measures within said twelve month period;
labeling said year to date measure data with an appropriate unit of measure;
stating a source from which said year to date measure data is to be collected;
demarcating an annual target and a red line target for each of said year to date measure data for said twelve month period;
entering said year to date measure data in said twelve month period to create entered year to date measure data for each of said performance measures;
updating said year to date measure data in said twelve month period to create updated year to date measure data for each of the performance measures;
calculating a progression of each of said entered year to date measure data and/or said updated year to date measure data in relation to said annual target and said red line target; and
displaying said progression of each of said entered year to date measure data and/or updated year to date measure data over said twelve month period.

2. The method of claim 1, wherein said listing step comprises identifying priorities and ensuring said organizational aims achieve each of said priorities.

3. The method of claim 1, wherein said specifying step comprises stating that each of said year to date measure data are entered monthly, quarterly, biannually, or annually.

4. The method of claim 1, wherein said displaying step further comprises showing a color-coded alert corresponding to said progression.

5. The method of claim 4, wherein said color-coded alert shows red when said year to date measure data has not surpassed said red line target.

6. The method of claim 4, wherein said color-coded alert shows yellow when said year to date measure data has surpassed said red line target and has not met said annual target.

7. The method of claim 4, wherein said color-coded alert shows green when said year to date measure data has met or surpassed said annual target.

8. The method of claim 1, wherein said displaying step comprises showing a bar chart showing a development of said year to date measure data over said twelve month period.

9. The method of claim 1, wherein said labeling step comprises choosing a unit of measure from the following: number, percentage, and dollar amount.

10. The method of claim 1, further comprising documenting protocols for collecting said year to date measure data from said source.

11. The method of claim 1, wherein said management method is carried out by Microsoft Excel.

12. The method of claim 1, wherein said displaying step utilizes a dashboard.

13. The method of claim 1, wherein said listing step comprises of listing organizational aims for each of a plurality of programs.

14. The method of claim 15, further comprising summarizing in a cumulative display said progression of each of said performance measures by said year to date measure data in relation to said annual target and said red line target for each of said programs, and presenting said cumulative display in a central dashboard.

15. The method of claim 1, further comprising recording a year end measure data for each of said performance measures for each of several consecutive twelve month periods, and evaluating a development of each of said year end measure data against said annual target and said red line target over said several consecutive twelve month periods.
